(19) United States
(12) Patent Application Publication
(10) Pub. No.: US 2010/0313854 A1
(43) Pub. Date: Dec. 16, 2010

(54) FUEL INJECTION CONTROL DEVICE OF INTERNAL COMBUSTION ENGINE

(75) Inventors: Keiki Tanabe, Kawasaki-shi (JP); Shinji Nakayama, Kawasaki-shi (JP); Fumitaka Komatsu, Kawasaki-shi (JP); Masaki Sugiura, Kawasaki-shi (JP)

Correspondence Address: ROSSI, KIMMS & McDOWELL LLP., 20609 Gordon Park Square, Suite 150, Ashburn, VA, 20147, US

(73) Assignee: MITSUBISHI FUSO TRUCK AND BUS CORPORATION, Kanagawa (JP)

(21) Appl. No.: 12/521,571

(22) PCT Filed: Dec. 10, 2007
(86) PCT No.: PCT/JP2007/073794

§ 371 Date: Aug. 24, 2009

(30) Foreign Application Priority Data
Dec. 27, 2006 (JP) 2006-352525
Dec. 27, 2006 (JP) 2006-352526

(51) Int. Cl. F02M 51/00

(52) U.S. Cl. 123/492

(57) ABSTRACT

In a common rail internal combustion engine having a pressure increase mechanism, when the pressure increase mechanism is activated, fuel is injected according to a target injection quantity determined by adding an increase in injection quantity calculated depending on a load on a supply pump to a demanded injection quantity.

### TECHNICAL FIELD

This invention relates to fuel injection control technology related to a common rail internal combustion engine having a pressure increase mechanism.

### BACKGROUND ART

There exists an internal combustion engine (hereinafter referred to as “engine”) provided with a so-called common rail fuel injection system, in which fuel pressurized by a pressurizing pump (supply pump) and stored in a common rail is injected into cylinders through fuel injection valves connected to the common rail according to set timing.

In recent years, there has been developed a fuel injection system in which fuel injection valves of the engine include a pressure increase mechanism so as to further increase the pressure of fuel from the common rail, before injection.

The provision of such pressure increase mechanism enables control varying injection pressure waveform, which is almost restricted to a rectangular waveform with the common rail fuel injection system without such pressure increase mechanism, and high-pressure injection not attainable with the common rail fuel injection system without such pressure increase mechanism. Further, pressure increase by the pressure increase mechanism allows a decreased common rail pressure, which leads to an increased durability of the common rail, etc.

The pressure increase mechanism increases the pressure of fuel by activating a pressure increase piston included therein, and normally, the pressure increase piston is activated by removing the fuel pressure acting thereon as a back pressure while deactivated, specifically by returning fuel exerting the back pressure to a fuel tank. This however results in an increase in consumption of pressurized fuel.

In response to this increase in consumption of pressurized fuel, the supply pump operates to increase fuel discharge in order to maintain the common rail pressure. This means that load on the supply pump, and thus, load on the engine driving the supply pump increases steeply, which leads to a reduction in engine torque, etc., thus, deterioration of drivability.

There is disclosed a configuration which alleviates such reduction in engine torque accompanying the activation of the pressure increase mechanism, by activating the pressure increase mechanism in a manner delaying actual start of pressure increase and gradually varying target rail pressure, or by blank shot control, namely opening a pressure increase control valve at times irrelevant to fuel injection, immediately before activating the pressure increase mechanism, and gradually increasing valve opening duration (see Japanese Patent Application KOKAI Publication 2006-132467).

The technology disclosed in Patent Document 1 mentioned above has however a problem that delay of start of pressure increase by the pressure increase mechanism leads to deteriorated response to target injection pressure.

Further, there is a possibility that opening the pressure increase control valve leads to a reduction in engine torque, even if it is performed at times irrelevant to fuel injection as in Patent Document 1.

Like this, the technology disclosed in Patent Document 1 mentioned above has a problem that activation of the pressure increase mechanism leads to unstable engine operating conditions.

### DISCLOSURE OF THE INVENTION

This invention has been made to solve the problems as mentioned above, and the primary object thereof is to provide a fuel injection control device of an internal combustion engine provided with a common rail system including a pressure increase mechanism, capable of activating a pressure increase mechanism without entailing a reduction in engine torque, while maintaining stable engine operating conditions, thus, offering improved drivability.

In order to achieve the above object, the fuel injection control device of the internal combustion engine according to the present invention comprises a pressurizing pump driven by power from the internal combustion engine; a common rail storing fuel pressurized by the pressurizing pump at a predetermined fuel pressure; a fuel injection valve injecting fuel stored in the common rail into a cylinder of the internal combustion engine; a pressure increase mechanism increasing the pressure of fuel from the common rail and sending the pressure-increased fuel to the fuel injection valve; a pressure increase mechanism control means performing activation/deactivation-control on the pressure increase mechanism, depending on operating conditions of the internal combustion engine; and a fuel injection control means controlling the fuel injection valve such that when the pressure increase mechanism is activated by the pressure increase mechanism control means, the fuel injection valve injects fuel according to a target injection quantity increased according to an increase in load on the pressurizing pump accompanying the activation of the pressure increase mechanism.

In other words, in the common rail engine including a pressure increase mechanism, when the pressure increase mechanism is activated, target injection quantity is increased according to an increase in load on the pressurizing pump to increase engine torque, thereby preventing a reduction in torque caused by the increase in load on the pressurizing pump.

Thus, a reduction in engine torque accompanying the activation of the pressure increase mechanism is prevented while maintaining stable engine operating conditions, so that improved drivability is offered.

It is desirable that the fuel injection control device further comprise a demanded injection quantity calculation means calculating demanded fuel injection quantity depending on demanded load on the internal combustion engine, and an injection increase setting means setting an increase in injection quantity depending on load on the pressurizing pump, wherein when the pressure increase mechanism is activated by the pressure increase mechanism control means, the fuel injection control means sets a target injection quantity by adding an increase in injection quantity set by the injection increase setting means to a demanded injection quantity set by the demanded injection quantity calculation means.

As stated above, when the pressure increase mechanism is activated, target injection quantity is obtained by adding an increase in injection quantity, which is set depending on load on the pressurizing pump, to a demanded injection quantity, which is set depending on demanded load on the internal combustion engine. Such target injection quantity is suited to cover an increase in load on the pressurizing pump, resulting in an increased reliability of preventing a reduction in engine torque.

In this case, it is desirable that when the demanded injection quantity calculated by the demanded injection quantity calculation means reaches or exceeds a preset threshold, the pressure increase mechanism control means activate the pressure increase mechanism, and that the fuel injection control means set a target injection quantity by adding an increase in injection quantity set by the injection increase setting means to a demanded injection quantity set by the demanded injection quantity calculation means as long as a differential between the threshold and the demanded injection quantity calculated by the demanded injection quantity calculation means is within a predetermined range.

Activating the pressure increase mechanism when the demanded injection reaches or exceeds a preset threshold, and setting an increased target injection quantity as long as a differential between the threshold and the demanded injection quantity is within a predetermined range after the activation of the pressure increase mechanism, thus, as long as the rate of change of load on the supply pump is great, can reduce useless increase of injection quantity and ensure safety.

It is desirable that the injection increase setting means set smaller increase in injection quantity for greater differential between the threshold and the demanded injection quantity calculated by the demanded injection quantity calculation means.

Setting smaller increase in injection quantity for greater differential between the threshold, preset as a criterion to activate the pressure increase mechanism, and the demanded injection quantity can reduce useless increase of fuel injection quantity and allow smooth transition to normal fuel injection quantity corresponding to demanded load.

It is desirable that the injection increase setting means calculate load on the pressurizing pump from revolving speed of the internal combustion engine and the demanded injection quantity, and set greater increase in injection quantity for lower revolving speed and for greater demanded injection quantity.

Setting greater increase in injection quantity for lower revolving speed of the internal combustion engine and for greater demanded injection quantity leads to setting an increase in injection quantity suited for load on the supply pump.

It is desirable that the fuel injection control device further comprise a target injection quantity setting map including fixed-accelerator-depression characteristic curves giving target injection quantity depending on revolving speed and accelerator depression quantity of the internal combustion engine, and a line setting a threshold of the target injection quantity depending on the revolving speed and the accelerator depression quantity, and defining a region over the threshold setting line as a region calling for activation of the pressure increase mechanism, wherein said fixed-accelerator-depression characteristic curves give a greater rate of change of the target injection quantity relative to the revolving speed in the region over the threshold setting line, compared with a region under the threshold setting line, so that the target injection quantity increases at an increased rate when the activation of the pressure increase mechanism causes an increase in load on the pressurizing pump; that the pressure increase mechanism control means control the activation of the pressure increase mechanism according to the target injection quantity setting map; and that the fuel injection control means control the fuel injection valve to inject fuel according to a target injection quantity obtained from the target injection quantity setting map.

Setting a target injection quantity according to such target injection quantity setting map can bring a steep increase in target injection quantity when the pressure increase mechanism is activated. Such increase in target injection quantity results in an increase in engine torque, thus supplementing the torque to cover an increase in load on the pressurizing pump accompanying the activation of the pressure increase mechanism.

It is desirable that the target injection quantity setting map give, in said region over the threshold setting line, a rate of change of the target injection quantity resulting in an increase in engine torque no less than that required to cover an increase in load on the pressurizing pump accompanying the activation of the pressure increase mechanism.

This enables causing a steep increase in target injection quantity when the pressure increase mechanism is activated, thereby increasing the engine torque to or above a level required to cover the load on the pressurizing pump when the pressure increase mechanism is activated, thus reliably preventing a reduction in engine torque.

It is desirable that the target injection quantity setting map give, in said region over the threshold setting line, a rate of change of the target injection quantity resulting in an increase in engine torque no less than that allowing a vehicle driver to feel acceleration.

This enables causing a steep increase in target injection quantity when the pressure increase mechanism is activated, thereby increasing the engine torque to a level allowing a vehicle driver to feel acceleration and therefore recognize the activation of the pressure increase mechanism.

### BRIEF DESCRIPTION OF THE DRAWINGS

FIG. 1 is a diagram schematically showing a configuration of a fuel injection control device of an internal combustion engine according to an embodiment of the present invention;

FIG. 2 is a pressure increase flag map provided in a fuel injection control device of an internal combustion engine according to a first embodiment of the present invention;

FIG. 3 is a block diagram showing fuel injection increase control which the fuel injection control device of the internal combustion engine according to the first embodiment of the present invention performs when a pressure increase mechanism is activated;

FIG. 4 is a time chart showing how operating conditions vary with time when the pressure increase mechanism is activated in the first embodiment of the present invention;

FIG. 5 is a pressure increase flag map provided in a fuel injection control device of an internal combustion engine according to a second embodiment of the present invention;

FIG. 6 is a target fuel injection quantity setting map provided in the fuel injection control device of the internal combustion engine according to the second embodiment of the present invention; and

FIG. 7 is a time chart showing how operating conditions vary with time under fuel injection control according to the target injection quantity setting map, performed by the fuel injection control device of the internal combustion engine according to the second embodiment of the present invention.

### BEST MODE OF CARRYING OUT THE INVENTION

Referring to the drawings, embodiments of the present invention will be described below.

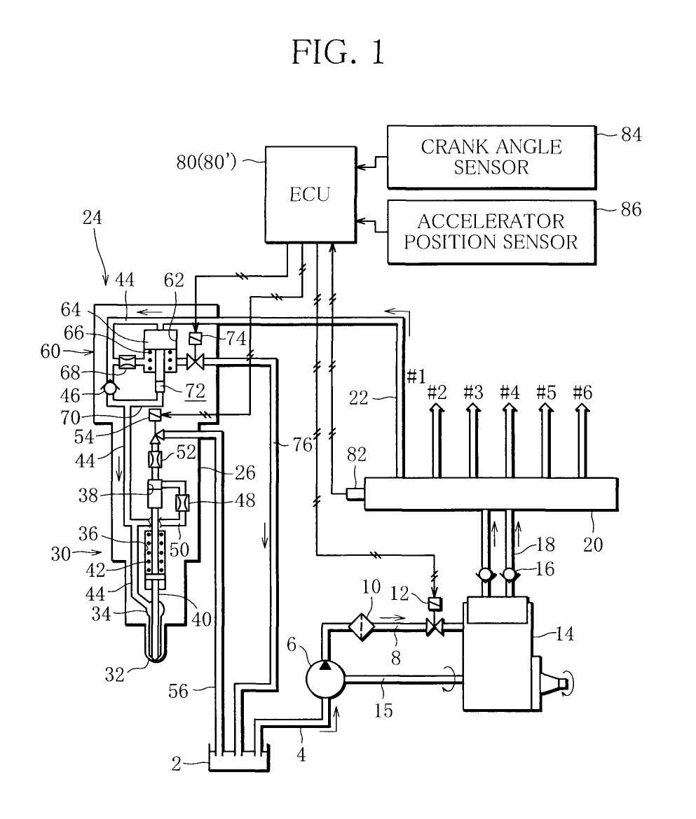

FIG. 1 schematically shows a configuration of a fuel injection control device of an internal combustion engine according to an embodiment of the present invention. The description below is based on this diagram.

The fuel injection device of FIG. 1 is applied to a six-cylinder diesel engine, not shown.

A fuel tank 2 is provided on a vehicle equipped with the diesel engine (hereinafter referred to simply as “engine”). The fuel tank 2 is connected to a feed pump 6 by a tank fuel line 4. The feed pump 6 is connected to a supply pump 14 (pressurizing pump) provided with a filter 10 and a fuel supply regulation solenoid valve 12 by a feed fuel line 8. The supply pump 14 is connected to a common rail 20 by a pair of supply fuel lines 18 each provided with a check valve 16. The feed pump 6 and the supply pump 14 are integrally linked by a shared drive shaft 15 driven by engine power.

The common rail 20 is connected to fuel injection valves 24, provided to face the respective cylinders of the engine, by common rail fuel lines 22.

The fuel injection valve 24 includes a fuel injection mechanism 30 controlling fuel injection into the cylinder, and a pressure increase mechanism 60 increasing the pressure of fuel before supply to the fuel injection mechanism 30, which are contained in a valve body 26.

The fuel injection mechanism 30 has a spout 32, a fuel reservoir 34, a spring chamber 36 and a pressure chamber arranged in line from the tip (lower end) of the valve body 26. A needle-shaped plunger 40 extends from the spout 32 to the pressure chamber 38. A spring 42 in the spring chamber 36 pushes downward on the needle-shaped plunger 40. The fuel reservoir 34 connects to an end of a fuel supply line 44, and the other end of the fuel supply line 44 connects to the common rail fuel line 22. The fuel supply line 44 is provided with a check valve 46, midway. Fuel from the common rail fuel line 22 is conveyed to the spout 32 via the fuel supply line 44 and the fuel reservoir 34.

An end of a pressure line 50 provided with a narrowing 48 connects to the fuel supply line 44, at an appropriate location downstream of the check valve 46. The other end of the pressure line 50 connects to the pressure chamber 38 at an upper location. Consequently, fuel pressure in the fuel supply line 44 acts on the upper face of the needle-shaped plunger 40 as a back pressure, inside the pressure chamber 38, while in the fuel reservoir 34, fuel exerts upward pressure on the needle-shaped plunger 40. Since the force resulting from the back pressure and the force exerted by the spring 42 is greater than the fuel pressure in the fuel reservoir 34, the needle-shaped plunger 40 is pushed down onto the spout 32 so that the fuel injection valve is closed.

An injection control solenoid valve 54 is connected to the top of the pressure chamber 38 by a line provided with a narrowing 52. The injection control valve 54 is connected to the fuel tank 2 by a return line 56. When the injection control valve 54 is opened, fuel in the pressure chamber 38 returns to the fuel tank 2 via the return line 56, resulting in a reduction in the back pressure acting on the needle-shaped plunger 40. Consequently, the needle-shaped plunger 40 is pushed up so that the fuel injection valve opens.

The pressure increase mechanism 60 is arranged above the fuel injection mechanism 30.

The pressure increase mechanism 60 includes a cylinder 62 consisting of an upper large-diameter part and a lower small-diameter part. A pressure increase piston 64 is fitted inside the cylinder 62 to be able to slide up and down. Corresponding to the cylinder 62, the pressure increase piston 64 consists of a large-diameter part and a small-diameter part. A spring 66 provided inside the cylinder 62 pushes upward on the pressure increase piston 64.

The cylinder 62 connects to the fuel supply line 44 at three locations. Specifically, a section of the fuel supply line 44 upstream of the check valve 46, provided with a narrowing 68, connects to the upper and lower sides of the large-diameter part of the cylinder 62, so that fuel pressure in the fuel supply line 44 acts on the lower side of the large-diameter part of the pressure increase cylinder 64 as a back pressure. A section of the fuel supply line 44 downstream of the check valve 46, on the other hand, is connected to the lower side of the small-diameter part of the cylinder 62 by a pressure increase line 70, so that a section of the cylinder defined by the lower side of the small-diameter part of the pressure increase piston 64 serves as a pressure increase chamber 72. The force resulting from the back pressure and the force exerted by the spring 66 is greater than the fuel pressure acting on the upper side of the large-diameter part of the pressure increase piston 64, so that the pressure increase piston 64 is pushed up, so that the pressure increase chamber 72 has a maximum volume.

A pressure increase control solenoid valve 74 is connected to the large-diameter part of the cylinder 62 at a lower location. The pressure increase control valve 74 is connected to the fuel tank 2 by a return line 76. When the pressure increase control valve 74 is opened, fuel under the large-diameter part of the cylinder 62 returns to the fuel tank 2 via the return line 76, resulting in a reduction in the back pressure acting on the pressure increase piston 64. Consequently, the pressure increase piston 64 is pushed down so that the pressure increase chamber 64 has a reduced volume.

In the vehicle interior, an ECU (electronic control unit) 80 including an input/output device, a storage device (ROM, RAM, etc.) to store control programs, control maps, etc., a central processing unit (CPU), a timer counter, etc., not shown, is installed. To the input of the ECU 80 are connected sensors, such as a common rail pressure sensor 82 detecting fuel pressure in the common rail 20 (hereinafter referred to also as “common rail pressure”), a crank angle sensor 84 sending out a crank angle pulse in synchronization with the revolving engine, an accelerator position sensor 86 detecting how much an accelerator pedal is depressed, etc. To the output of the ECU 80 are connected devices, such as the fuel supply regulation valve 12, the injection control valve 54 and pressure increase control valve 74 of each fuel injection valve 24, etc. The ECU 80 drive-controls the devices on the basis of information from these sensors.

Next, the function of the fuel injection control device of the internal combustion engine and control performed by the ECU 80 according to the present invention will be described.

Fuel is fed from the fuel tank 2 to the supply pump 14 by the feed pump 6, and pressurized and supplied to the common rail 20 by the supply pump 14, where the ECU 80 controls the degree to which the fuel supply regulation valve 12 is opened, thereby restricting the amount of fuel supplied to the supply pump 14, thereby regulating the amount of fuel discharged by the supply pump 14. Specifically, the opening degree of the fuel supply regulation valve 12 is feedback-controlled to maintain actual rail pressure, detected by the common rail pressure sensor 82, at a target for it.

When fuel should be injected into the cylinder at the common rail pressure, namely without increasing the pressure, the injection control valve 54 is opened with the pressure increase control valve 74 closed. Consequently, fuel in the pressure chamber 38 is returned to the fuel tank 2 via the return line 56, so that the needle-shaped plunger 40 is pushed up and fuel starts being injected through the spout 32. Then, when the injection control valve 54 is closed, the fuel flow to the fuel tank 2 ceases, so that the needle-shaped plunger 40 is pushed down and fuel injection ceases.

When, on the other hand, pressure should be increased by the pressure increase mechanism 60, the pressure increase control valve 74 is opened.

When the pressure increase control valve 74 is opened, fuel under the large-diameter part of the cylinder 62 is returned to the fuel tank 2 via the return line 76, so that the pressure increase piston 64 is pushed down. This increases the fuel pressure in the pressure increase chamber 72, so that the fuel downstream of the check valve 42 in the fuel supply line 44 has a pressure increased over the common rail pressure.

When the injection control valve 54 is opened in this state, the injection pressure immediately rises rapidly and is held at a level higher than the common rail pressure. Then, when the injection control valve 54 and the pressure increase control valve 74 are closed in this order, the injection pressure decreases so that the fuel injection ceases.

The activation/deactivation of the pressure increase mechanism 60 and the fuel injection are controlled by the ECU 80 (pressure increase mechanism control means, fuel injection control means) depending on engine operating conditions.

Next, the pressure increase mechanism control and fuel injection control by the ECU 80 according to first and second embodiments will be described.

First, the first embodiment will be described.

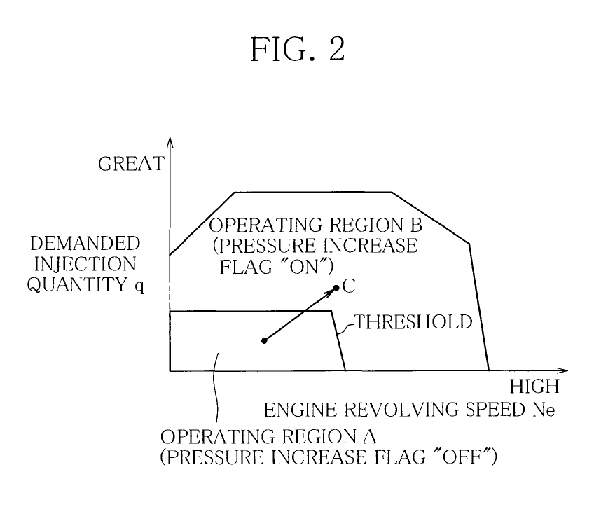

FIG. 2 shows a pressure increase flag map provided in the fuel injection control device of the internal combustion engine according to the first embodiment of the present invention.

In the first embodiment, demanded fuel injection quantity is calculated from demanded load, specifically accelerator pedal depression quantity detected by the accelerator position sensor 86 (demanded injection quantity calculation means), and target fuel injection pressure is calculated on the basis of the demanded injection quantity and engine revolving speed detected by the crank angle sensor 84.

In the ECU 80, there is stored a pressure increase flag map M1 defining operating regions in which the pressure increase mechanism 60 should be activated and deactivated, depending on engine revolving speed and demanded injection quantity, thus, target fuel injection pressure, as shown in FIG. 2. Specifically, the pressure increase flag map M1 defines an operating region A under a specified revolting speed and a specified demanded injection quantity in which the common rail pressure can by itself achieve the target injection pressure, as a pressure increase flag “OFF” region, namely a region in which the pressure increase mechanism 60 should be deactivated, and an operating region B over and inclusive of the specified revolting speed and the specified demanded injection quantity in which the common rail pressure cannot by itself achieve the target injection pressure, as a pressure increase flag “ON” region, namely a region in which the pressure increase mechanism 60 should be activated.

The ECU 80 performs activation/deactivation-control on the pressure increase mechanism 60, depending on engine revolving speed and demanded fuel injection quantity, according to the pressure increase flag map M1.

If, for example, an acceleration results in a transfer from the operating region A to the operating region B in the pressure increase flag map M1, as indicated by arrow C in FIG. 2, so that the pressure increase mechanism 60, which was deactivated, is activated, fuel exerting a back pressure on the pressure increase piston 64 is returned to the fuel tank 2. Since this results in an increase in pressurized fuel consumption, the ECU 80 controls the fuel supply valve 12 to increase the amount of fuel discharged by the supply pump 14 to maintain the common rail pressure. Such increase in fuel discharge by the supply pump 14 means a steep increase in load on the supply pump 14, and thus, entails a steep increase in load on the engine driving the supply pump 14.

Thus, in order to prevent a reduction in engine torque caused by a steep increase in engine load accompanying the activation of the pressure increase mechanism 60, the fuel injection control device of the internal combustion engine according to the first embodiment of the present invention performs fuel injection increase control.

Next, this fuel injection increase control will be described in detail.

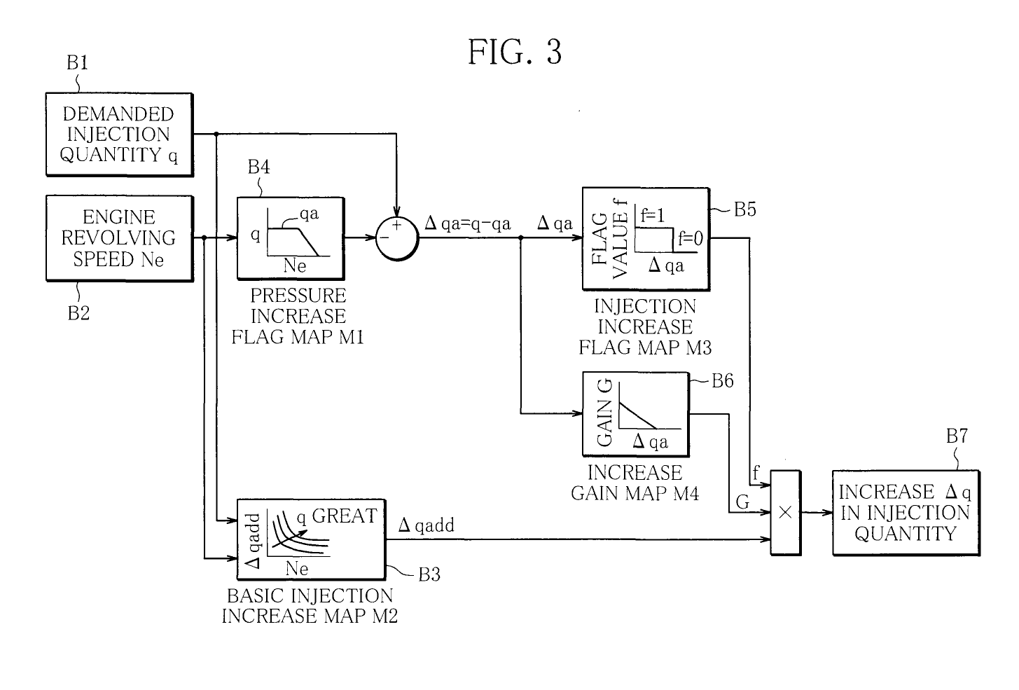

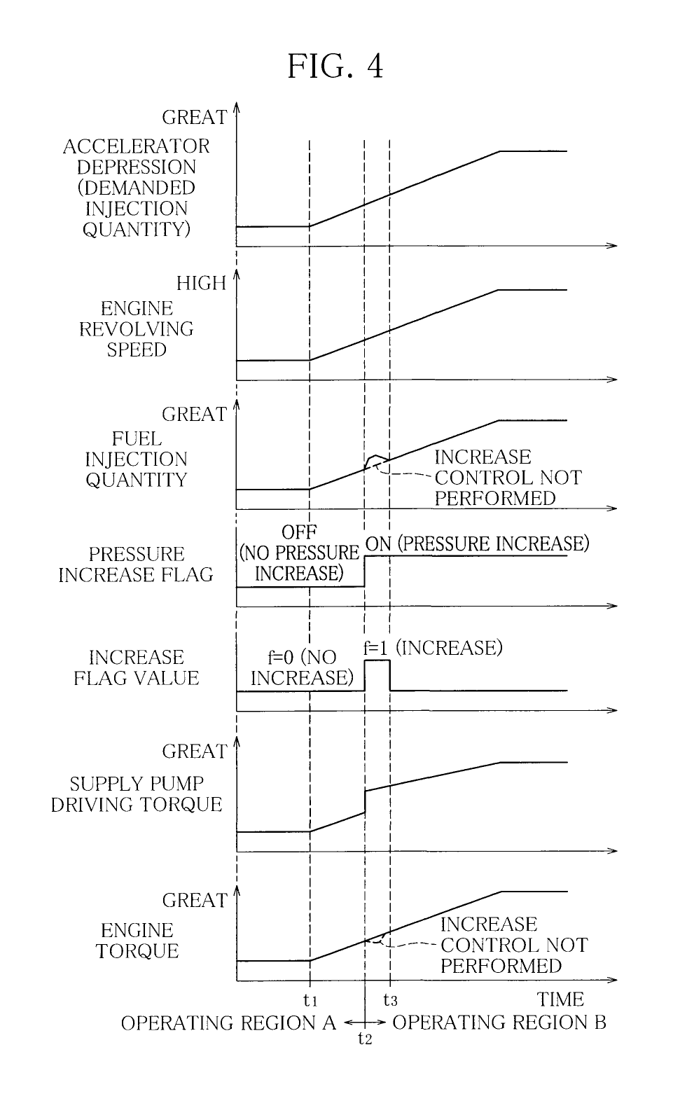

FIG. 3 is a block diagram showing fuel injection increase control performed by the fuel injection control device of the internal combustion engine according to the first embodiment of the present invention when the pressure increase mechanism is activated, and FIG. 4 is a time chart showing how operating conditions vary with time, when the pressure increase mechanism 60, which was deactivated, is activated.

First, a description will be given according to the block diagram of FIG. 3.

In block B1, a demanded injection quantity q calculated from an output of the accelerator position sensor 86 is obtained, and in block B2, an engine revolving speed Ne detected by the crank angle sensor 84 is obtained.

In block B3, from a basic injection increase map M2 stored in the ECU 80, a basic increase Δqadd in injection quantity for the demanded injection quantity q and engine revolving speed Ne obtained in blocks B1 and B2 is obtained. The basic injection increase map M2 is prepared to give greater basic increase Δqadd in injection quantity for lower engine revolving speed Ne and for greater demanded injection quantity q. The reason is as follows: The operating conditions with lower engine revolving speed Ne and greater demanded injection quantity q entail greater load on the supply pump 14, and thus, the reduction in engine torque accompanying the activation of the pressure increase mechanism 60 is correspondingly greater. In order to compensate for it, greater basic increase Δqadd in injection quantity is given. In short, the basic injection increase map M2 gives basic increase Δqadd in injection quantity depending on load on the supply pump 14 (injection increase setting means).

In order to perform injection increase control over a certain period after the pressure increase mechanism 60 is activated, specifically while a differential between a preset threshold qa of demanded injection quantity and the demanded injection quantity q is in a predetermined range, and to ensure that the fuel injection quantity returns to a level under normal fuel injection control at the time the injection increase control ceases, an injection increase flag and an increase gain are set in block B4 and subsequent blocks.

Specifically, in block B4, from the pressure increase flag map M1 of FIG. 2 giving a threshold of demanded injection quantity as a boundary between the operating regions A and B, a threshold qa for the engine revolving speed Ne obtained in block B2 is obtained.

Then, a differential Δqa between the demanded injection quantity q obtained in block B1 and the threshold qa is calculated. In other words, how far the demanded injection quantity q is away from the threshold qa is calculated.

Then, in block B5, the injection increase flag is set to a value f for the obtained differential Δqa, according to an injection increase flag map M3 stored in the ECU 80. The injection increase flag map M3 is prepared to assign an injection increase flag value “1” to differentials Δqa less than a predetermined value, and an injection increase flag value “0” to differentials Δqa no less than the predetermined value.

In block B6, the increase gain G is set to a value for the obtained differential Δqa, according to an increase gain map M4 stored in the ECU 80. The increase gain map M4 is prepared to assign smaller increase gain G value to greater differential Δqa and assign an increase gain G value “0” to differentials Δqa no less than a predetermined value. Thus, the increase gain G takes its maximum (“1”, for example) when the differential Δqa is “0”, i.e., at the time the pressure increase mechanism 60 is activated, and decreases as the differential Δqa increases to the predetermined value. In the present embodiment, the differential Δqa for which the increase gain G takes “0” in the increase gain map M4 coincides with the differential Δqa for which the injection increase flag value f takes “0” in the injection increase flag map M3.

Then, in block B7, an increase Δq in injection quantity is calculated by multiplying the basic increase Δqadd in injection quantity set in block B3 by the injection increase flag value f set in block B5 and the increase gain G set in block B6.

The ECU 80 performs fuel injection according to a target injection quantity determined by adding the calculated increase Δq in injection quantity to the aforementioned demanded injection quantity q.

Next, referring to FIG. 4, how the operating conditions vary under the injection increase control will be described specifically.

First, from time t1 until time t2 in FIG. 4, the engine revolving speed and the accelerator depression quantity, or in other words, the demanded injection quantity is in the operating region A in the pressure increase flag map M1 of FIG. 2 so that the pressure increase flag is “OFF”. As acceleration is caused by depressing the accelerator pedal, the engine revolving speed and the fuel injection quantity gradually increase, so that the supply pump 14 driving torque and the engine torque increase.

Then at time t2, the demanded injection quantity, which depends on the engine revolving speed, reaches or exceeds the threshold preset in the pressure increase flag map M1. Consequently, the pressure increase flag changes to “ON” and the pressure increase control valve 74 of the pressure increase mechanism 60 is opened, so that the supply pump 14 driving torque steeply increases.

Simultaneously with this, the injection increase flag value f for fuel increase control is set to “1”, the increase gain G is set to its maximum, and the target injection quantity is increased by an increase Δq in injection quantity determined by multiplying a basic increase Δqadd in injection quantity by the injection increase flag value f and the increase gain G.

Injecting fuel according to the target injection quantity thus increased results in an increase in engine torque, which compensates for a steep increase in the supply pump 14 driving torque.

This allows the engine torque to increase constantly after time t2, according to an increase in accelerator depression, without experiencing a reduction as seen in the conventional case.

Between times t2 and t3, under further acceleration, the pump 14 driving torque becomes stable and the differential Δqa increases, so that the increase gain G for fuel increase control decreases. With the decrease in increase gain, the increase Δq in injection quantity decreases, so that the target injection quantity approaches the demanded injection quantity. Then at time t3, the differential Δqa reaches the predetermined value, so that the increase gain G and the injection increase flag value f are set to “0”. Consequently, the increase Δq in injection quantity becomes “0”, so that the target injection quantity coincides with the demanded injection quantity.

As described above, in the first embodiment, when the pressure increase mechanism 60 provided in the common rail engine is activated, engine torque is increased by the above-described injection increase control, to compensate for a steep increase in supply pump 14 driving torque accompanying the activation of the pressure increase mechanism 60.

The injection increase control is performed only while the differential Δqa between the demanded injection quantity q and the threshold qa to activate the pressure increase mechanism 60, preset in the pressure increase flag map M1 is in a predetermined range, and the increase gain G set according to the increase gain map M4 decreases as the differential Δqa increases. This reduces useless increase of injection quantity and enables smooth transfer to normal fuel injection control.

Further, the basic increase Δqadd in injection quantity, on the basis of which the increase Δq in injection quantity is determined, is set to be greater for lower engine revolving speed Ne and for greater demanded injection quantity q. This leads to calculation of suitable increase Δq in injection quantity, depending on the load on the supply pump 14.

Thus, the fuel injection control device of the internal combustion engine according to the first embodiment of the present invention can satisfactorily compensate for a steep increase in supply pump 14 driving torque accompanying the activation of the pressure increase mechanism 60, thereby preventing a reduction in engine torque, while maintaining stable engine operating conditions, and thus, offer improved drivability.

Next, the pressure increase mechanism control and fuel injection control according to the second embodiment will be described.

In the second embodiment, the ECU 80′ performs activation/deactivation-control on the pressure increase mechanism 60 according a pressure increase flag map M1′ and fuel injection control according to a target injection quantity setting map M2′.

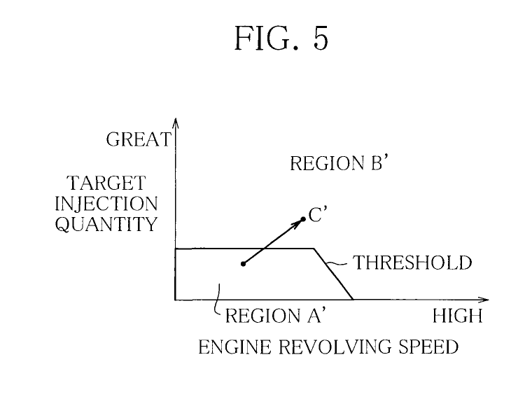

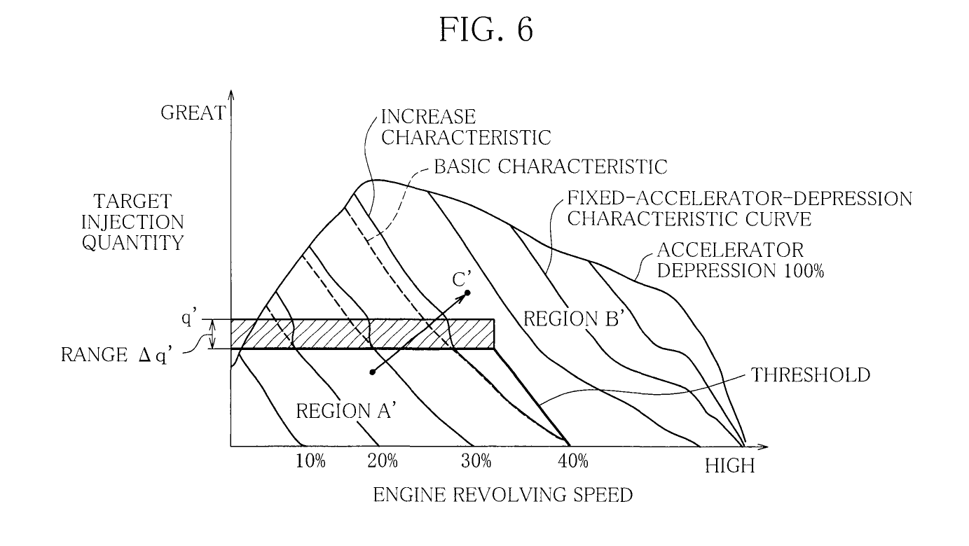

FIGS. 5 and 6 show a pressure increase flag map M1′ and a target fuel injection quantity setting map M2′ in the fuel injection control device of the internal combustion engine according to the second embodiment of the present invention, respectively.

Like the pressure increase flag map M1 in the first embodiment, the pressure increase flag map M1′ of FIG. 5 defines operating regions in which the pressure increase mechanism 60 should be activated and deactivated, depending on engine revolving speed and target fuel injection quantity. Specifically, the pressure increase flag map M1′ defines an operating region A′ under a specified revolting speed and a specified target injection quantity in which the common rail pressure can by itself achieve the target injection pressure calculated from the engine revolving speed and target injection quantity, as a pressure increase flag “OFF” region, and an operating region B′ over and inclusive of the specified revolting speed and the specified target injection quantity in which the common rail pressure cannot by itself achieve the target injection pressure, as a pressure increase flag “ON” region.

In other words, the threshold of target injection quantity is preset depending on engine revolving speed, and the ECU 80′ activates the pressure increase mechanism 60 when the target injection quantity reaches or exceeds the threshold. The threshold of target injection quantity is preset to be constant for engine revolving speeds lower than a predetermined value and gradually decrease at a constant rate for engine revolving speeds no lower than the predetermined value.

If, for example an acceleration results in a transfer from the operating region A′ to the operation region B′ in the pressure increase flag map M1′, as indicated by arrow C′ in FIG. 5, so that the pressure increase mechanism 60, which was deactivated, is activated, this entails a steep increase in load on the supply pump 14, and therefore, a steep increase in load on the engine driving the supply pump 14, as explained with respect to the first embodiment.

Thus, the fuel injection control device of the internal combustion engine according to the second embodiment of the present invention performs fuel injection according to a target injection quantity obtained from the target fuel injection setting map M2′ shown in FIG. 6, thereby preventing a reduction in engine torque caused by a steep increase in engine load accompanying the activation of the pressure increase mechanism 60.

The target injection quantity setting map M2′ shown in FIG. 6 gives target injection quantity depending on engine revolving speed for different accelerator depression quantities.

Specifically, the target injection quantity setting map M2′ allows the target injection quantity required to achieve the demanded power output, which is determined according to the specifications and characteristics of a vehicle, to be obtained from engine revolving speed and accelerator depression quantity. In the target injection quantity setting map M2′, such target injection quantity is indicated as basic characteristic curves. For example, for a fixed engine revolving speed, target injection quantity increases with an increase in accelerator depression quantity.

The target injection quantity setting map M2′ includes fixed-accelerator-depression characteristic curves set for each accelerator depression quantity, which represent how the target injection quantity varies depending on the engine revolving speed for a fixed accelerator depression quantity. Specifically, as seen from FIG. 6, each fixed-accelerator-depression characteristic curve shows that the target injection quantity increases as the engine revolving speed decreases.

To the target injection quantity setting map M2′, the threshold preset in the increase flag map M1′ is applied. The fixed-accelerator-depression characteristic curves intersecting the line representing the threshold are set to deflect over the threshold line.

Specifically, the fixed-accelerator-depression characteristic curves intersecting the threshold line each agree with the basic characteristic curve in a region A′ under the threshold line, but describe an increase characteristic curve giving increased target injection quantities compared with the basic characteristic curve, in a region B′ over the threshold line.

More specifically, the fixed-accelerator-depression characteristic curves intersecting the threshold line each have a steeper gradient in a region between the threshold line and the line representing a specified target injection quantity q′ no less than the threshold, compared with the basic characteristic curve indicated in broken line. Thus, in this region, the target injection quantity varies relative to the engine revolving speed and the accelerator depression quantity at an increased rate, so that an increase in engine revolving speed and accelerator depression quantity in this region results in a rapid increase in target injection quantity to the specified target injection quantity q′. Here, the increase Δq′ in injection quantity, namely the difference between the threshold and the specified target injection quantity q′ is set to an amount resulting in an increase in engine toque allowing a driver to sufficiently feel acceleration, by experiment or the like. Naturally, this increase Δq′ in injection quantity is no less than an amount required to cover an increase in load on the supply pump 14 accompanying the activation of the pressure increase quantity 60.

The fixed-accelerator-depression characteristic curves intersecting the threshold line are each set to have a gradient approximately equal to that of the basic characteristic curve in a region over the line representing the specified target injection quantity q′. Thus, the target injection quantities which the fixed-accelerator-depression characteristic curves intersecting the threshold line give in the region over the line representing the specified target injection quantity q′, depending on engine revolving speed and accelerator depression quantity, are increased, compared with those given by basic characteristic curves.

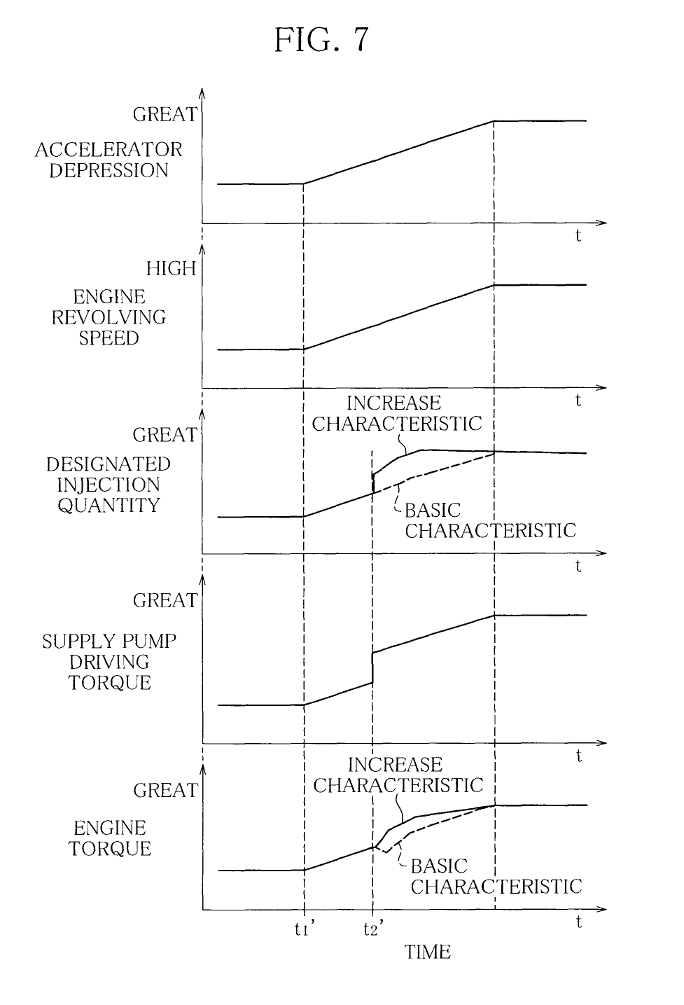

FIG. 7 is a time chart showing how the operating conditions vary with time under the fuel injection control according to the target injection quantity setting map M2′. Next, the description will be given on the basis of this diagram.

In FIG. 7, first, the engine revolving speed and the accelerator depression quantity are in the pressure increase mechanism deactivation region A′ in the pressure increase flag map M1′ of FIG. 5. Between times t1′ and t2′ in FIG. 4, the engine revolving speed and the fuel injection quantity gradually increase as acceleration is caused by depressing the accelerator pedal. With the acceleration, the supply pump 14 driving torque and the engine torque increase.

Then at time t2, the target injection quantity reaches or exceeds the threshold preset depending on the engine revolving speed in the pressure increase flag map M1′ of FIG. 5. Consequently, the pressure increase flag changes to “ON” and the pressure increase control valve 74 of the pressure increase mechanism 60 is opened, so that the supply pump 14 driving torque, or in other words, load steeply increases.

At this time, the accelerator depression quantity is at a value for which the fixed-accelerator-depression characteristic curve intersects the threshold line in the target injection quantity setting map M2′ of FIG. 6. Thus, the target injection quantity increases steeply, resulting in an increase in engine torque. This increase in engine torque covers a steep increase in load on the supply pump 14, thereby preventing a reduction in engine torque accompanying the activation of the pressure increase mechanism 60. On the contrary, the engine torque increases to a level allowing the driver to sufficiently feel acceleration.

After time t2′, the engine is operated to produce an increased torque, compared with the engine torque produced according to the basic characteristic curve, as long as the accelerator depression quantity is in a range of values for which the fixed-accelerator-depression characteristic curve intersects the threshold line. When the accelerator depression quantity goes out of this range, the engine torque returns to a level determined by the fuel injection quantity according to the basic characteristic curve.

As described above, in the target injection quantity setting map M2′ giving target injection quantity depending on engine revolving speed and accelerator depression quantity, the fixed-accelerator-depression characteristic curves intersecting the threshold line preset according to the pressure increase flag map M1′ are set to give a greater rate of change of target injection quantity in the range between the threshold line and the line representing the specified target injection quantity q′, compared with that under the threshold line, to steeply increase the target injection quantity when the pressure increase mechanism 60 is activated.

The steep increase in target injection quantity brings an increase in engine torque, which covers an increase in load on the supply pump 14 accompanying the activation of the pressure increase mechanism 60.

Consequently, a reduction in engine torque accompanying the activation of the pressure increase mechanism 60 is prevented while maintaining stable operating conditions of the internal combustion engine, and thus, improved drivability is offered.

In the aforementioned region, the target injection quantity is increased by the amount Δq allowing the driver to sufficiently feel acceleration. By feeling the acceleration, the driver can recognize that the pressure increase mechanism 60 has been activated.

In the above, fuel injection control devices of the internal combustion engine as embodiments of the present invention have been described. The present invention is, however, not limited to the described embodiments.

For example, the fuel injection devices described above as embodiments are applied to the diesel engine, but not limited to the application to the diesel engine. They may be applied to a common-rail direct-injection gasoline engine, etc.

In the injection quantity increase control in the first embodiment, the differential for which the increase gain G takes “0” coincides with the differential for which the injection increase flag value f takes “0”, but they may differ from each other.

In the first embodiment, the increase gain G is set to decrease with an increase in differential Δqa between demanded injection quantity q and threshold qa, i.e., a criterion to activate the pressure increase mechanism 60. The increase gain G may, however, be set depending on a variable other than the differential Δqa. For example, the increase gain G may be set to decrease with time after the pressure increase mechanism 60 is activated. Also the injection increase flag value f may be set depending on time elapsed after the activation.

In the second embodiment, the threshold preset in the increase flag map M1′ is a constant. The map may however preset the threshold as a variable. Likewise, the specified target injection quantity in the target injection quantity setting flag map M2′ may be a variable.

1. A fuel injection control device of an internal combustion engine, comprising:
a pressurizing pump driven by power from the internal combustion engine,
a common rail storing fuel pressurized by the pressurizing pump at a predetermined fuel pressure,
a fuel injection valve injecting fuel stored in the common rail into a cylinder of the internal combustion engine,
a pressure increase mechanism increasing the pressure of fuel from the common rail and sending the pressure-increased fuel to the fuel injection valve,
a pressure increase mechanism control means performing activation/deactivation-control on the pressure increase mechanism, depending on operating conditions of the internal combustion engine, and
a fuel injection control means controlling the fuel injection valve such that when the pressure increase mechanism is activated by the pressure increase mechanism control means, the fuel injection valve injects fuel according to a target injection quantity increased according to an increase in load on the pressurizing pump accompanying the activation of the pressure increase mechanism.

2. The fuel injection control device of the internal combustion engine according to claim 1, further comprising
a demanded injection quantity calculation means calculating demanded fuel injection quantity depending on demanded load on the internal combustion engine, and
an injection increase setting means setting an increase in injection quantity depending on load on the pressurizing pump, wherein
when the pressure increase mechanism is activated by the pressure increase mechanism control means, the fuel injection control means sets a target injection quantity by adding an increase in injection quantity set by the injection increase setting means to a demanded injection quantity set by the demanded injection quantity calculation means.

3. The fuel injection control device of the internal combustion engine according to claim 2, wherein
when the demanded injection quantity calculated by the demanded injection quantity calculation means reaches or exceeds a preset threshold, the pressure increase mechanism control means activates the pressure increase mechanism, and
the fuel injection control means sets a target injection quantity by adding an increase in injection quantity set by the injection increase setting means to a demanded injection quantity set by the demanded injection quantity calculation means as long as a differential between the threshold and the demanded injection quantity calculated by the demanded injection quantity calculation means is within a predetermined range.

4. The fuel injection control device of the internal combustion engine according to claim 2, wherein
the injection increase setting means sets smaller increase in injection quantity for greater differential between the threshold and the demanded injection quantity calculated by the demanded injection quantity calculation means.

5. The fuel injection control device of the internal combustion engine according to claim 2, wherein
the injection increase setting means calculates load on the pressurizing pump from revolving speed of the internal combustion engine and sets greater increase in injection quantity for lower revolving speed of the internal combustion engine and for greater demanded injection quantity.

6. The fuel injection control device of the internal combustion engine according to claim 1, further comprising
a target injection quantity setting map including fixed-accelerator-depression characteristic curves giving target injection quantity depending on revolving speed and accelerator depression quantity of the internal combustion engine, and a line setting a threshold of the target injection quantity depending on the revolving speed and the accelerator depression quantity, and defining a region over the threshold setting line as a region calling for activation of the pressure increase mechanism, wherein
said fixed-accelerator-depression characteristic curves give a greater rate of change of the target injection quantity relative to the revolving speed in the region over the threshold setting line, compared with a region under the threshold setting line, so that the target injection quantity increases at an increased rate when the activation of the pressure increase mechanism causes an increase in load on the pressuring pump,
the pressure increase mechanism control means control the activation of the pressure increase mechanism according to the target injection quantity setting map, and
the pressure injection control means controls the fuel injection valve to inject fuel according to a target injection quantity obtained from the target injection quantity setting map.

7. The fuel injection control device of the internal combustion engine according to claim 6, wherein
the target injection quantity setting map gives, in said region over the threshold setting line, a rate of change of the target injection quantity resulting in an increase in engine torque no less than that required to cover an increase in load on the pressurizing pump accompanying the activation of the pressure increase mechanism.

8. The fuel injection control device of the internal combustion engine according to claim 6, wherein
the target injection quantity setting map gives, in said region over the threshold setting line, a rate of change of the target injection quantity resulting in an increase in engine torque no less than that allowing a vehicle driver to feel acceleration.
